(19) United States
(12) Patent Application Publication
(10) Pub. No.: US 2017/0236342 A1
(43) Pub. Date: Aug. 17, 2017

(54) VEHICLE KEY ACTIVATED TRAVEL LOG SYSTEM

(71) Applicant: FORD GLOBAL TECHNOLOGIES, LLC, Dearborn, MI (US)

(72) Inventor: Jan Linus MATTSSON, Thornbury VIC (AU)

(73) Assignee: FORD GLOBAL TECHNOLOGIES, LLC, Dearborn, MI (US)

(21) Appl. No.: 15/436,049

(22) Filed: Feb. 17, 2017

(30) Foreign Application Priority Data
Feb. 17, 2016 (CN) 201610089868.2

(51) Int. Cl. G07C 5/08; G07C 9/00; G06Q 10/10; G07C 5/00; G06Q 40/00

(52) U.S. Cl. CPC G07C 5/0841; G07C 5/008; G06Q 40/10; G06Q 10/10; G07C 9/00015; G07C 9/00103; G06F 17/30368

(57) ABSTRACT

A vehicle key activated travel log system of a vehicle includes a first key with a first key identification code; a second key with a second key identification code different from the first key identification code; and a travel log unit to identify first key and the second key. The system generates a first log book when the first key is identified to start the vehicle.

### CROSS-REFERENCE TO RELATED APPLICATIONS

This application claims foreign priority benefits under 35 U.S.C. §119(a)-(d) to CN patent application 2016 100 898 68.2 filed Feb. 17, 2016, which is hereby incorporated by reference in its entirety.

### TECHNICAL FIELD

The present disclosure relates to a travel log system and a method that can activate a travel log with minimum user action and generate the log book that accurately records the business travels.

### BACKGROUND

A private vehicle can be used for business travels. The cost for driving the vehicle for the business travels can be reimbursed from a company if a driver works for a company. The cost for driving the vehicle for the business travel can be tax deductible if a driver travels for his/her own business in some countries. However, travel related information needs to be recorded as evidence to claim the tax deduction or the reimbursement. For these purposes, the required information can include the date of travel, odometer readings at a start location and an end location of a trip, or fuel cost among others. Recording information for each business travel and maintaining a travel log can be burdensome and tedious for the driver.

U.S. Pat. No. 5,046,007 to McCrery discloses a device for collecting travel-related data for a motor vehicle. Data collection begins when the ignition system of the vehicle is activated. The data collection device records the travel-related data for a trip whenever the data collection device is powered up and the ignition of a vehicle engine is detected.

The disclosure has recognized that the data collection device of McCrery has various issues when used in a private vehicle to record a business travel. In particular, McCrery does not distinguish the business travel and the private travel automatically. An effort from a user is required to correctly record the business trips. For example, if a user wants to only record data for the business trips, the user has to power up the data collection device for each business trip and makes sure that the data collection device is powered off for a private trip. An inappropriate action or omission of the action from the user will resulting inaccurate travel log, which may record a personal trip or omit a business trip.

### SUMMARY

According to one aspect of the present disclosure, a vehicle key activated travel log system of a vehicle may be provided. The vehicle key activated log system may comprise a first key with a first key identification code; a second key with a second key identification code different from the first key identification code; and a travel log unit to identify first key and the second key, and generate a first log book when the first key is identified to start the vehicle.

In one embodiment, the first key may be a first work key for business travel, and the second key may be a private use key for personal travel.

In another embodiment, the first key may be a first work key for business travel, and the second key may be a private use key for personal travel. The vehicle key activated travel log system may further comprise a key code transceiver to receive the first and second key identification codes and transmit the first and second key identification codes to the travel log unit; a memory to store the first log book; and a user interface for a user to input travel-related information and display data from the first log book.

In another embodiment, the first key may be a first work key for business travel, and the second key may be a private use key for personal travel. The travel log unit may be communicated with a vehicle control unit to obtain readings of an odometer, and the first log book may include a date of a work trip, a work trip start time, a work trip end time, an odometer reading at a start of the work trip, and an odometer reading at an end of the work trip.

In another embodiment, the first key may be a first work key for business travel, and the second key may be a private use key for personal travel. The first log book further may include a mileage of a current work trip and a cumulative mileage of previous work trips up to the current work trip, or a fuel consumption of the current work trip and a cumulative fuel consumption of work trips during a tax year.

In another embodiment, the first key may be a first work key for business travel, and the second key may be a private use key for personal travel. The first log book further may include a mileage of a current work trip and a cumulative mileage of previous work trips up to the current work trip, or a fuel consumption of the current work trip and a cumulative fuel consumption of work trips during a tax year. The first log book may further include a fuel consumption of the current work trip and a cumulative fuel consumption of work trips during a tax year.

In another embodiment, the travel log unit may be communicated with a human machine interaction (HMI) device of the vehicle to enable a user to input trip information via a user interface of the HMI device and display data from the first log book to the user interface of the HMI device.

In another embodiment, the first key may be a first work key for business travel, and the second key may be a private use key for personal travel. The travel log unit may be communicated with a human machine interaction (HMI) device of the vehicle to enable a user to input trip information via a user interface of the HMI device and display data from the first log book to the user interface of the HMI device. The trip information may include a purpose of the work trip, or a company or people visited.

In another embodiment, the first key may be a first work key for business travel, and the second key may be a private use key for personal travel. The travel log unit may be communicated to a navigation unit of the vehicle and a work trip starting location may be recorded when the vehicle is started, and wherein a work trip ending location is recorded when the vehicle is stopped.

In another embodiment, the first key may be a first work key for business travel, and the second key may be a private use key for personal travel. Information from the first log book may be retrievable by a user via a user's account with a telematics server.

In another embodiment, the first key may be a first work key for business travel, and the second key may be a private use key for personal travel. The vehicle key activated travel log system may further comprise a data port in an HMI device or in the first work key, and information from the first log book may be transmitted from the data port to a personal computing device or to a storage device.

In another embodiment, the first key may be a first work key for business travel, and the second key may be a private use key for personal travel. The vehicle key activated travel log system may further comprise a second work key for business travel having a third key identification code. The travel log unit may be activated to generate a second log book when the key identification unit recognizes that the second work key is used to start the vehicle.

According to another aspect of the present disclosure, a vehicle key activated travel log system in a vehicle is provided. The vehicle key activated travel log system may include a work key for business travel having a first identification code; a private use key for personal travel having a second identification code; a key code transceiver; a travel log unit activated to generate a log book when a key used to start the vehicle is identified as the work vehicle key; a travel log display subunit in an HMI device to display information from the first log book; and an input and output subunit in the HMI for input and output of travel-related information and data.

In one embodiment, the log book includes a date of a work trip, a work trip start time, a work trip end time, an odometer reading at a start of the work trip, and an odometer reading at an end of the work trip.

In another embodiment, the vehicle key activated travel log system may further comprise a data port for transferring data of the log book, wherein the data port is disposed in a HMI device of the vehicle, or in the work key.

According to another aspect of the present disclosure, a method of generating a travel log for a vehicle is provided. The vehicle may include a work key and a private use key to start the vehicle. The method may comprise receiving a vehicle key identification code embedded in the work key or the private use key; and generate a log book when a received vehicle key identification code is identified as a code embedded in the work key.

In one embodiment, the method may further comprise recording a date of a work trip, a work trip start time, a work trip end time, an odometer reading at a start of the work trip and an odometer reading at an end of the work trip.

In another embodiment, the method may further comprise receiving vehicle location information, and recording a work trip start location and a work trip end location into the work log book.

In another embodiment, the method may further comprise calculating a mileage of the current work trip, and calculating a cumulative mileage by adding the mileage of the current work trip to mileages of previous work trips in the log book.

In another embodiment, the method may further comprise receiving input from a user via a user interface of an HMI device in the vehicle and recording the input into the log book, wherein the input includes a purpose of the trip, a company visited, or people visited.

In another embodiment, the method may further comprise displaying data from the log book on a user interface of the HMI device in response to a user's request.

In another embodiment, the method may further comprise displaying data from the log book on a user interface of the HMI device in response to a user's request. Only the input by the user may be modified by the user.

In another embodiment, the method further comprises transmitting information from the log book to a personal computing device or a storage device via a data port of the HMI device.

In another embodiment, the travel log unit may be not activated when the received car key identification code does not match the code embedded in the work vehicle key.

The vehicle key activated travel log system and method described above allow generation of a travel log by a specific key such as a work key. A travel log is automatically generated whenever the work key is used to start the vehicle. As long as a user selects the work key for the business travel, the travel related information for the business travel is recorded. In this way, the travel log can provide accurate and complete records on the user's business travels.

It should be understood the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 depicts an embodiment of computing environment in which example embodiments of a travel log system of the present disclosure may be implemented.

FIG. 2 is a block diagram of an example vehicle system in which an example embodiment of a travel log system of the present disclosure may be implemented.

FIG. 3 shows an example work key used in a travel log system of the present disclosure.

FIG. 4 is a block diagram of an example in-vehicle device in which example embodiments of the present disclosure may be implemented.

FIG. 5 shows an example method to activate a travel log system by a vehicle key according to an embodiment of the present disclosure.

FIG. 6 shows an example user interface of a travel log system of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description will be omitted.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

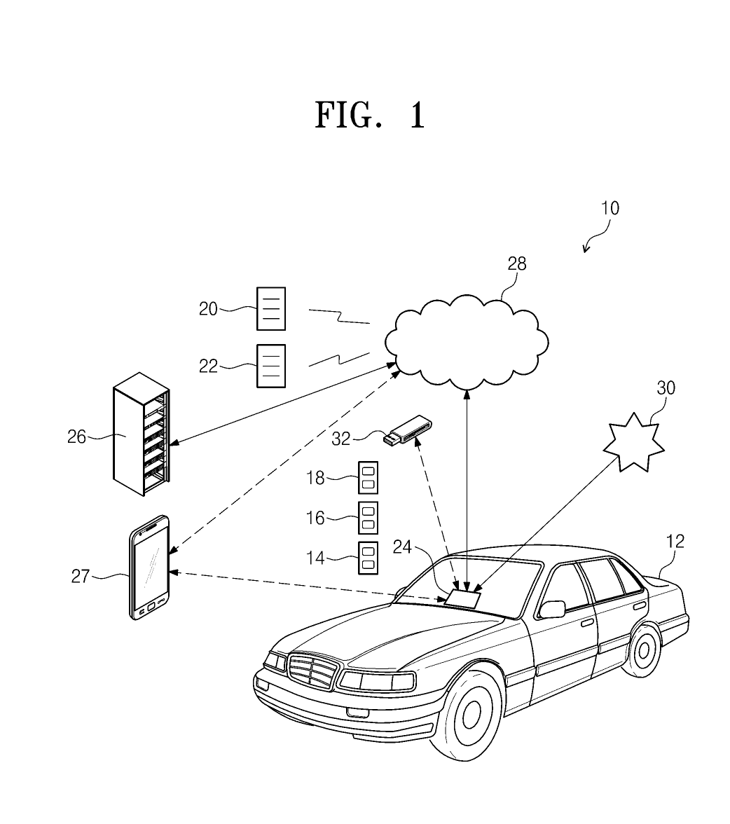

FIG. 1 depicts an embodiment of computing environment in which example embodiments of a travel log system of the present disclosure may be implemented. The computing environment may be a telecommunications and/or data-processing system applicable to mobile devices such as vehicles and may be referred as a telematics system 10. The telematics system 10 may support travel log, navigation, control, communications, and/or entertainment of a vehicle 12, for example. Its travel log aspect may provide features to monitor the location of the vehicle 12, generate a travel log, store and transmit the travel log, for example. The telematics system 10 may include the vehicle 12 and a set of keys that start the vehicle 12. In some embodiments, a first work key 14 may be configured for business travels for a first driver and may be embedded with a first key identification code. A first log book 20 may be generated when the first work key is used to start the vehicle 12. A private use key 16 may be configured for personal travel and embedded with a second key identification code. A travel log may not be generated when the private use key 16 is used to start the vehicle. In some embodiments, the vehicle 12 may further include a second work key 18 embedded with a third key identification code. The second work key may be used by a second driver. A second log book 22 may be generated when the second work key 18 is used to start the vehicle 12.

The telematics system 10 may include an in-vehicle device 24 with a user interface. A vehicle key activated travel log system may be implemented in the in-vehicle device. Further, the in-vehicle device 24 may allow for input, output and display of information. The in-vehicle device 24 may be any computing device associated with the vehicle 12 or a driver.

In some embodiments, the in-vehicle device 24 may be a human machine interaction (HMI) device. The HMI device may be a telecommunications and/or a data-processing device permanently or removably installed in the vehicle 12 to provide features such as navigation, entertainment, vehicle information and vehicle control. As described in detail in FIG. 4, a vehicle key activated travel log system may be implemented in the HMI device or may communicate with the HMI device. A user interface of the HMI may be used to input, output and display the travel related information or the log book.

In some embodiments, the in-vehicle device 24 may be a travel log device only used for the travel log purpose. In other embodiments, the in-vehicle device 24 may be a driver's cell phone or other computing device in which a vehicle key activated log system may be implemented.

The telematics system 10 may comprise a telematics server 26 that may provide various services to the vehicle 12. In some embodiments, the telematics server 26 may include a travel log service and/or an account related service. The travel log service may store travel related information such as log books 20 and 22. Further, the travel log service may provide a travel log application that implements a vehicle key activated travel log system. A user may subscribe the travel log service and download the travel log application to the vehicle 12 via telematics network 28.

In some embodiments, the travel log application may be downloaded to the vehicle 12 without being connected to the telematics server 26. For example, a memory device 32 may be used to download the travel log application to the vehicle 12. Similarly, the log books may be saved and stored in the memory device 32.

The telematics system 10 may further comprise one or more client computers 27. A client 27 may be a personal computer, smartphone, tablet device, touchpad device or other device and may be connected to the network 28 by a wireless and/or hardwired connection. A user may access the log books 20 and 22 by logging into the telematics server 26 from a user's account via the client 27.

The network 28 may include the Internet. When the vehicle 12 is moving, the network 28 may employ one or more wireless communications technologies such as Wi-Fi, a cellular-telephone services such as 3G or 4G networks, direct satellite links, and/or terrestrial radio-frequency links. Any of these technologies, alone or in combination, may provide for data transfer between the vehicle 12, the telematics server 26, the HMI device 24 and other devices of the telematics system 10 over the internet connection.

Positioning system 30 may be any device or system capable of determining the location of the vehicle 12. For example, the positioning system 30 may be a navigational system that transmits signals from satellite or terrestrial sources to receivers such as Global Positioning System (GPS). The GPS employs multiple satellites that broadcast signals containing time and position data. The GPS receiver can use the signals to determine a location. In another example, the positioning system 30 may be a terrestrial positioning system that may employ signals from transmitters that are one or more stationary antennas in known locations. Signals from cell-phone towers, for example, can be used to calculate the location of a receiver. In yet another example, the positioning system 30 may be a device that tracks location by dead reckoning. The dead-reckoning device may employ inertial navigation and/or sensors built into a vehicle. For example, a compass that measures direction combined with a drivetrain sensor that measures distance may provide position data such as a distance offset from a known starting point. It should be appreciated that the positioning system 30 may employ more than one technology.

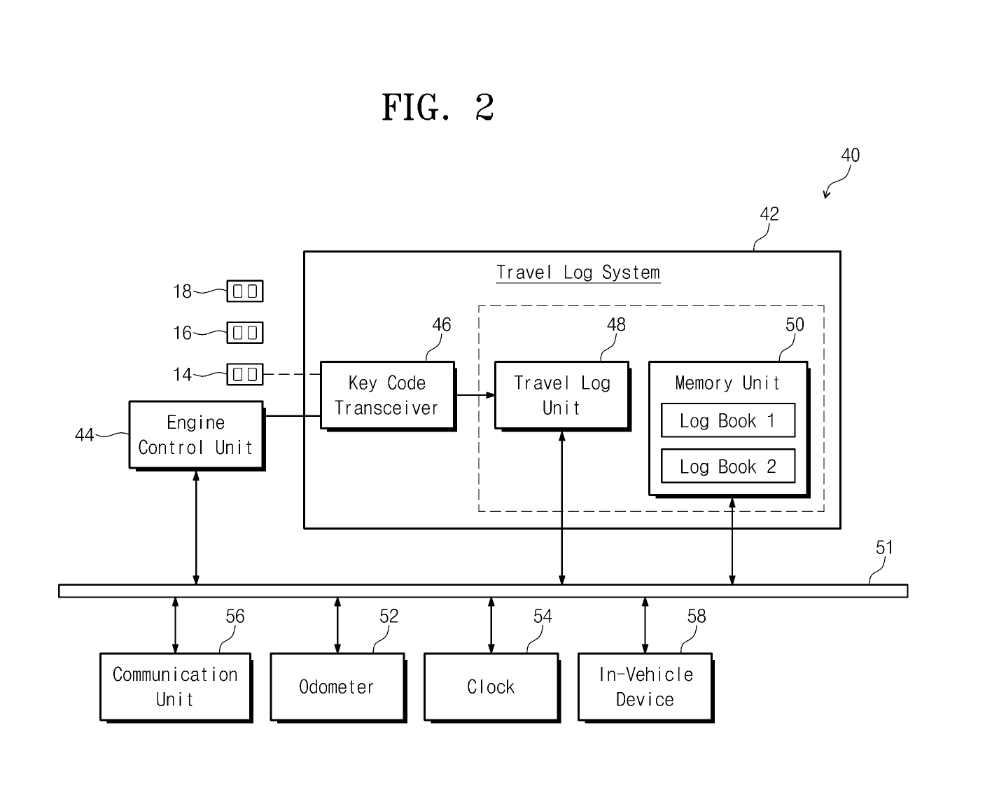

FIG. 2 is a block diagram of an example vehicle system 40 in which an example embodiment of a travel log system 42 of the present disclosure may be implemented and illustrates the communications between the travel log system 42 and some electronic devices of the vehicle 12. The vehicle system 40 may include an engine control unit 44 conventionally used in the art. For example, the engine control unit 44 may control a series of actuators on an internal combustion engine, to ensure optimal engine performance. The actuators may be adjusted by reading values from a multitude of sensors within the engine bay and interpreting the data using multidimensional performance maps. The vehicle system 40 may further include other control units such as vehicle stability control unit, traction control unit and climate control unit (not shown in FIG. 2). It should be appreciated that the engine control unit 44 is illustrated as an example embodiment. The vehicle may be an electric vehicle or a hybrid electric vehicle with corresponding control unit.

The vehicle system 40 may include the travel log system 42 that activates a travel log by a designated vehicle key. The travel log system 42 may include a plurality of vehicle keys each embedded with an identification code, a key code transceiver 46, and a travel log unit 48 and a memory unit 50. The vehicle may include at least one work key 14 for the business travel and at least one private use key 16 for the personal travel, each having a unique key identification code. In one embodiment, the vehicle key may be a mechanical key that starts the vehicle by inserting into a keyhole and turning a switch that connects the battery to the ignition system and other electrical devices of the vehicle. In another embodiment, the vehicle key may be a smart key that automatically unlocks, locks and starts the vehicle.

The key code transceiver 46 may receive the key identification code and transmit it to the travel log unit 48. Any suitable technology may be used for the key identification. For example, in some embodiments, the vehicle key may include a radio pulse generator unique for the key as an identification code and the key code transceiver 46 may include an antenna that receives the radio signal from the key and transmits the signal to the travel log unit 48. In some embodiments, the vehicle key may include an electromagnetic field as an identification code. The electromagnetic field may include an electronically readable data that may be transmitted to the travel log unit 48 via the key code transceiver 46. It should be appreciated that any technology for the key identification known in the art may be used.

The travel log unit 48 may include a processor that provides for computational resources. The travel log unit 48 may serve to execute instructions for software that may be loaded into a memory unit 50. The instructions may include program code, computer-usable program code, or computer-readable program code. The memory unit 50 may be a storage device that is capable of storing information, such as, without limitation, data, program code in functional form, and/or other suitable information on either a temporary basis and/or a permanent basis. For example, the memory unit 50 may include a random access memory or any other suitable volatile or non-volatile storage device and a persistent storage. The persistent storage may be one or more devices such as a hard drive, a flash memory, a rewritable optical disk, a rewritable magnetic tape, or some combination of the above.

The travel log unit 48 may recognize the key identification code of the vehicle keys. When a first work key 14 is recognized to start the vehicle 12, the travel log unit 48 is activated to generate a travel log by recording the travel related information and generating a log book 20. The log book 20 may be associated with the use of the first work key by a first driver. When the first driver uses the first work key for a business travel, the travel information associated with him/her is recorded in the log book 20. When a private use key 16 is used to start the vehicle, the travel log may not be activated.

In some embodiments, a second work key 18 may be provided for generating a second log book. The vehicle 12 may be driven by a second driver for business travels. When the second work key 18 is recognized to start the vehicle, the travel log is activated to record the travel related information and generate the log book 22. In other words, the log book 22 may be associated with the use of the second work key by the second driver. When the second driver uses the second work key 18 for the business travel, the travel information associated with him/her is recorded in the log book 22. Alternatively, the second work key 18 may be used to record specific travels instead of business travels of the second driver. For example, the second work key may be used during long trips or vacation trips where the driver wants to keep record on the mileage and fuel consumption. The second log book 22 may serve this purpose.

The travel log unit 48 may determine a start of the vehicle 12. Any suitable method may be used to designate the start of the vehicle for the travel log purpose. In some embodiments, the vehicle may be powered by a gasoline engine or a diesel engine. The start of the vehicle may be determined when a start motor of the engine operates or the engine starts running. In some embodiments, the vehicle may be a hybrid electric vehicle. The start of the vehicle may be determined when the engine starts running or an electric motor for the vehicle propulsion starts running. In some embodiments, the vehicle may be an electric vehicle. The start of the vehicle may be determined when an electric motor for the vehicle propulsion starts running.

The travel log unit 48 may determine an end of a trip. The trip may be ended when the vehicle is stopped and the vehicle key is taken off In some embodiments, the vehicle may be powered by a gasoline engine or a diesel engine and the vehicle stop may be determined when the engine stops running. In some embodiments, the vehicle may be a hybrid electric vehicle and the vehicle stop may be determined when an engine or an electric motor for the vehicle propulsion stops running. In some embodiments, the vehicle may be an electric vehicle and the vehicle stop may be determined when an electric motor stops running.

The travel log unit 48 may be communicated with various devices of the vehicle via a communication bus 51 to obtain the travel related information. For example, the travel log unit 48 may be connected with an odometer 52 and an internal clock 54 of the vehicle 12 and thus enable recording of the odometer readings and date/time when the vehicle starts and stops.

In some embodiments, the travel log unit 48 may further be communicated with a communication unit 56 that provides for communications with other data processing system or devices. For example, the communication unit 56 may be a network interface card and may communicate with the positioning system 30 as illustrated in FIG. 1 so that the location of the vehicle can be determined. As such, the travel log unit 48 may record a trip start location when the vehicle starts and a trip ending location when the vehicle stops.

In some embodiments, the travel log unit 48 may further be communicated with an in-vehicle device 58. The in-vehicle device 58 may be a device 24 described in FIG. 1. The in-vehicle device 58 may include a user interface having an input/output unit and a display. The user can enter information such as a purpose of the work trip, or a company or people visited. Such information may be recorded in the log book. In some embodiments, the information entered by the user may be modified. However, the information not entered by the user may not be modified by the user. Such information may include a date, odometer readings, fuel consumption and/or location. The display may present the log book to the user.

The travel log unit 48 may process the travel related information and store the data in a log book. For example, the mileage for a work trip or a business travel may be calculated from the odometer readings. In another example, fuel consumption for the trip may be determined based on actual fuel used for the trip from data in the vehicle system. In yet another example, cost for the trip may be estimated based on the fuel consumption, cost of fuel and other factors. The travel log unit 48 may determine a cumulative mileage of previous work trips up to the current work trip, a fuel consumption of the current work trip and a cumulative fuel consumption of previous work trips up to the current work trip, or a subtotal/total cost of previous work trips up to the current work trip.

The travel log system 42 of the present disclosure may be implemented in a program code or an application. In some embodiments, the travel log application may be available as an option or a standard of a vehicle. In some embodiments, the travel log application may be available for purchasing by a user. The travel log application may be downloaded to the vehicle from the telematics server 26 via the network 28 or may be downloaded to the vehicle via a storage device such as a universal serial bus (USB) flash drive or secure digital (SD) card. In some embodiments, the vehicle keys are embedded with the identification code and the vehicle is equipped with an in-vehicle device such as HMI device. The travel log system can be implemented simply by installation of the application. Once installed, the travel log system may become a subsystem of the HMI device as described in detail in FIG. 4 below. In some embodiments, the coded keys may be provided along with the travel log application when the user purchases the travel log application.

The travel related information or the log book stored in the memory 50 may be transferred from the travel log system 42 to other devices. In some embodiments, the in-vehicle device 58 may include a data port to transfer the travel related information or the log book to a storage device such as a USB flash drive or a SD card. In some embodiments, a work key may include a memory device such as a USB flash drive or a SD card. The log book may be transferred to the memory device of the work key. In some embodiments, the log book may be saved in the telematics server 26 under a user's account. The user may access the log book by his/her own computer, smart phone or other computing device that is connected to the network 28.

The travel log system of the present disclosure can record the travel related information for the business travels accurately and automatically. As the travel log is activated whenever the vehicle is started by a work key, the travel related information is automatically recorded and the information for a work trip cannot be lost. Further, the recording of a private travel into a log book can be avoided because no data recording on the travel is performed when the vehicle is started by the private use key. In this way, the log book can be ensured to record the business travels accurately as long as the user picks up the correct key for the travel. Furthermore, the travel log system only allows the user to modify the data in the limited entries and does not permit the user to change the information on the date, odometer readings, locations and fuel consumption of the trip, for example. As a result, the log book provides reliable data to be used for expense reimbursement and tax deduction, for examples.

In some embodiments, a vehicle key activated travel log system of a vehicle may comprise a first key with a first key identification code; a second key with a second key identification code different from the first key identification code; and a travel log unit to identify first key and the second key, and generate a first log book when the first key is identified to start the vehicle. No log book is generated when the second key is used. Thus, the first key may be used when a user needs to record the travel related information for specific trips. For example, as described above, the first key may be a work key used only for the business travels or work trips. In another example, the first key may be used only for specific trips like vacation trips when the user wants to have a travel log for personal information. The vehicle key activated travel log system allows generation of a travel log by a vehicle key. A user can use this vehicle key for specific trips and the travel related information is automatically recorded whenever this vehicle key is used to start the vehicle.

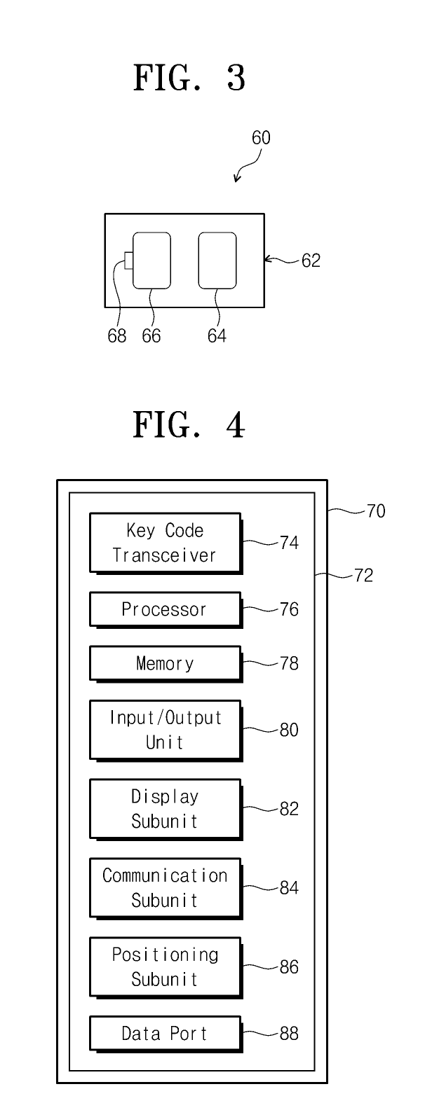

FIG. 3 shows an example work key 60 of a travel log system of the present disclosure. The work key 60 may include a key body 62 and a key identification code 64 embedded in the key body 62.

In some embodiments, the work key 60 may be a smart key that automatically locks and unlocks a door and starts the vehicle without inserting the key into a key hole. The work key may further include a memory 66 and a data port 68. In some embodiments, the memory 66 may receive a log book associated with the work key 60 via wireless communication with the travel log unit of the travel log system. The log book may be stored in the memory 66 and may be transmitted to other computing device such as a personal computer via the data port 68. In some embodiments, the memory 66 may be a USB flash drive or a SD card which is removably installed in the key body 62. The USB flash drive or the SD card may be used to download the log book associated with the work key 60 from an in-vehicle device.

It should be appreciated that any suitable form of keys may be used for the travel log system of the present disclosure. For example, the work key 60 may be a mechanical vehicle key with notches to start the ignition of an engine or a motor. A key identification code may be embedded in the key body of the mechanical key.

Similarly, a personal use key may be provided. The personal use key may include a key identification code that is different from that of the work key.

The vehicle may be provided with a plurality of work keys and a plurality of personal use keys. In some embodiments, only one log book may be generated for driving the vehicle. Each of the plurality of work keys may include a first key identification code and may be used to generate one log book. Each of the plurality of personal use keys may include a second key identification code different from the first key identification code and no log book may be generated when the personal use key is used to start the vehicle.

In some embodiments, two log books may be generated for driving the vehicle. The vehicle may be provided with a plurality of first work keys, a plurality of second work keys, and a plurality of personal use keys. Each of the plurality of first work keys may include a first key identification code, the plurality of personal use keys may include a second key identification code, and each of the plurality of second work keys may include a third key identification code. The first key identification code, the second key identification code and the third key identification code may be different from each other. When the first work key is used to start the vehicle, a first log book is generated. When the second work key is used to start the vehicle, a second log book is generated. When the private use key is used to start the vehicle, no log book is generated. In this way, the vehicle may be used by two persons for business travels and a separated log book is generated for each person.

FIG. 4 shows a block diagram of a HMI device 70 of a vehicle in which example embodiments of the present disclosure may be implemented. The HMI device 70 may be a telecommunications and/or data processing device permanently or removably installed in the vehicle 12. The HMI device may provide features such as vehicle information, entertainment, navigation, travel log and/or vehicle control. The HMI device 70 may comprise a travel log system 72 and may further comprises other elements, systems, or devices providing the features include but not limited to the features described above. The present disclosure discusses the travel log aspects of the HMI device 70 even though other aspects may be present.

The travel log system 72 may be a portion of the HMI devices 70 devoted to the travel log feature. The travel log system 72 may include a vehicle key transceiver 74, a processor 76 and a memory 78, an input/output unit 80, a display subunit 82, a communication subunit 84, and a positioning subunit 86. The vehicle key transceiver may receive a signal from a vehicle key and transmit the signal to the processor 76. The processor 76 may provide computational resources for the travel log system 72. The travel log unit 48 described in association with FIG. 2 may be run in the processor 76. The travel log system 72 (or its host HMI device 70) may employ one or more processors to run programs to support the display subunit 82, the communication subunit 84, and the positioning subunit 86 and/or other features. The memory 78 may provide program and data storage for the processor.

The input/output unit 80 may allow a user to regulate the operation of the travel log system 72. For example, the input/output unit 80 may include a keyboard to input alphanumeric data, a user interface or a touch-screen interface of display subunit. In one example, the user interface may allow the user to define a business travel such as a purpose of the work trip, or a company or people visited. The user interface may further allow the user to modify the data entered by the user such as a purpose of the work trip, or a company or people visited. However, the user may not be allowed to change the data automatically generated in the log book such as a date, odometer readings, a start location and an end location, and fuel consumption of the trip.

The display subunit 82 may include the user interface to display information/data from the log book. The display subunit 82 may include a display component such as LCD or LED panel. The display subunit 82 may further implement input/output or control of the travel log system 72 via the display subunit 82, for example, through touch-screen technology.

The communication subunit 84 may be one or more receivers and/transmitters that allow the travel log system 72 to connect to the network 28 as described in FIG. 1. The communication subunit 84 may employ a wireless communication link such as Wi-Fi, cellular communications, and/or satellite communication. The connection may be used to communicate with the telematics server 26 to transmit the updated log book to the telematics server 26 as described in FIG. 1.

The positioning subunit 86 may include one or more receivers, transmitters, and/or sensors to determine the location of the vehicle 12.

In some embodiments, the HMI device 70 may include a data port 88 such as a USB port or secured digital (SD) card slot. The data port 88 may allow the user to plug a USB flash drive or a SD card into the data port 88 and save the log book to the USB flash drive or the SD card. The data port 88 may also allow the user to install an application of the travel log system to the HMI device 70.

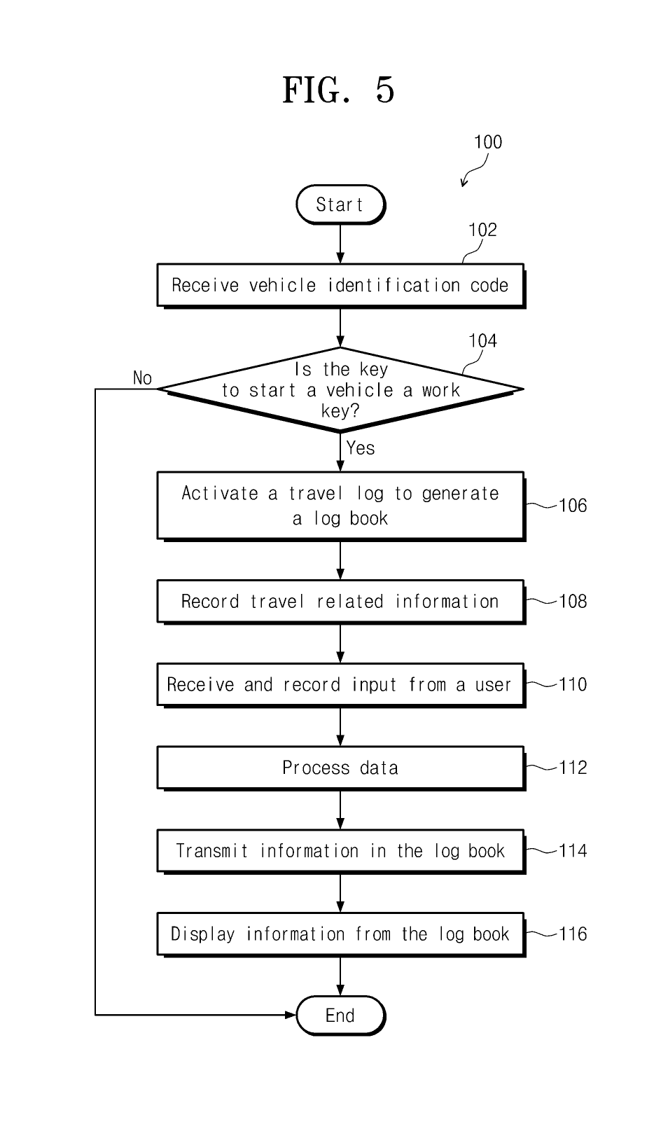

FIG. 5 shows an example of a method 100 of generating a travel log for a vehicle according to an embodiment of the present disclosure. The vehicle may include a plurality of keys to start the vehicle. Among them, at least one key may be a work key for business travel with a first key identification code and at least one key may be a private use key for personal travel with a second key identification code different from the first key identification code.

At 102, method 100 includes receiving a vehicle key identification code when a key is used to start the vehicle. In some embodiments, the vehicle may be started when the key is inserted into a key hole and activates the ignition switch. In some embodiments, the vehicle may be started when the key is located adjacent to a driver seat and a driver presses a start button of the vehicle. At 104, method 100 includes determining whether the key to start the vehicle is the work key. If the answer at 104 is no, the private use key is used to start the vehicle, the method ends. That is, a travel log is not generated when the private use key is used to start the vehicle.

As described above, a vehicle may be provided with more than one work key. Method 100 may recognize the different work keys.

If the answer at 104 is yes, method 100 continues to 106. At 106, method 100 includes activating a travel log to generate a log book. The log book corresponds to the work key used to start the vehicle. For example, a log book 1 may be generated when a first work key is used and a log book 2 is generated when a second work key is used. Next, at 108, the method includes recording travel related information in the log book. The travel related information may include a date of a work trip, a work trip start time, a work trip end time, an odometer reading at a start of the work trip and an odometer reading at an end of the work trip. The travel related information may further include a work trip start location and a work trip end location into the log book.

At 110, method 100 includes receiving an input from a user and recording the input. The input may include a purpose of the trip, a company visited, or people visited or other information. The user may input the information via a user interface of an in-vehicle device such as an HMI device of the vehicle. The user may input the information before driving, after the trip or at any appropriate time.

At 112, method 100 includes processing data in the log book. For example, method 100 may calculate a mileage of a current work trip, and a cumulative mileage by adding the mileage of the current work trip to mileages of previous work trips in the log book. In another example, method 100 may calculate fuel consumption of a current work trip, and a cumulative fuel consumption by adding the fuel consumption of the current work trip to the fuel consumption of previous work trips in the log book. In yet another example, method 100 may calculate the cost of the driving the vehicle for a trip based on fuel consumption and other factors. The data may be processed to present information that meets the requirements for tax purposes and/or business expense report.

At 114, method 100 includes transmitting travel related information or the log book. In some embodiments, the log book may be transmitted to a storage device such as a USB flash drive or a SD card via a data port of an in-vehicle device such as a HMI device. In some embodiments, the log book may be transmitted to a memory of the work key. In some embodiments, the log book may be transmitted to a personal computer or other devices via a network.

At 116, method 100 includes displaying the log book to the user. In some embodiments, the log book may be displayed on an interface of an in-vehicle device such as an HMI device.

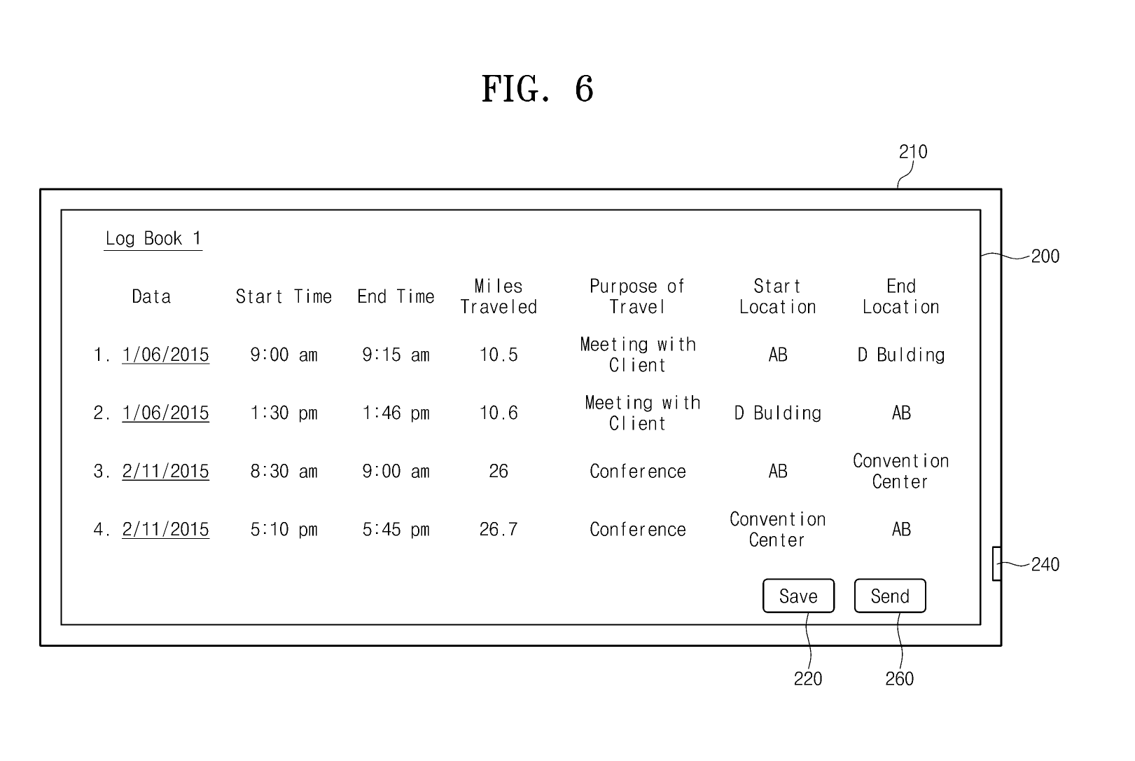

Now, referring to FIG. 6, an example user interface 200 of the travel log system of the present disclosure is illustrated. In some embodiments, the user interface 200 may be a touch screen included in an in-vehicle device 210 such as an HMI device of a vehicle or a travel log device. The user interface 200 may implement input, output and display of a log book. In the illustrated example, a log book 1 associated with a first work key is displayed on the user interface 200. A log book 1 displayed may include the travel related information such as a date, a start time, an end time, a mileage, a start location, an end location and purpose of a trip. It should be appreciated that the interface may display additional information such as cumulative millage, the fuel consumption, cumulative fuel consumption, cost of driving, or subtotal/total cost of driving.

The user interface 200 may allow a user to change some information in the log book 1. For example, the user may change the description of the travel such as the purpose of travel. The user interface 200 may further include a plurality of commands to perform specific tasks. For example, the user interface 200 may include a “Save” button 220 to allow the user to save the log book 1 to a USB flash drive or a SD card via a data port 240. Additionally, the user interface 200 may include a “Send” button 260 to enable the user to send the work log book 1 to his/her personal computing device via an email.

Similarly, if a travel log system includes a second work key, a log book 2 associated with the second work key may be displayed and the user may enter or change selected information in the log book 2.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle key activated travel log system of a vehicle, comprising
a first key with a first key identification code;
a second key with a second key identification code different from the first key identification code; and
a travel log unit to identify the first and second keys and generate a first log book responsive to identifying the first key as being used to start the vehicle.

2. The vehicle key activated travel log system of claim 1, wherein the first key is a work key for business travel, and the second key is a private use key for personal travel.

3. The vehicle key activated travel log system of claim 2, further comprising:
a key code transceiver to receive the first and second key identification codes and transmit the first and second key identification codes to the travel log unit;
a memory to store the first log book; and
a user interface for a user to input travel-related information and display data from the first log book.

4. The vehicle key activated travel log system of claim 2, wherein the travel log unit is communicated with an odometer of the vehicle to obtain readings of an odometer, and
wherein the first log book includes a date of a work trip, a work trip start time, a work trip end time, an odometer reading at a start of the work trip, and an odometer reading at an end of the work trip.

5. The vehicle key activated travel log system of claim 4, wherein the first log book further includes a mileage of a current work trip and a cumulative mileage of previous work trips up to the current work trip, or a fuel consumption of the current work trip and a cumulative fuel consumption of work trips during a tax year.

6. The vehicle key activated travel log system of claim 5, wherein the travel log unit is communicated with a human machine interaction (HMI) device of the vehicle to enable a user to input trip information via a user interface of the HMI device and display data from the first log book to the user interface of the HMI device.

7. The vehicle key activated travel log system of claim 6, wherein the trip information includes a purpose of the work trip, or a company or people visited.

8. The vehicle key activated travel log system of claim 5, wherein the travel log unit is communicated to a navigation unit of the vehicle, wherein a work trip starting location is recorded when the vehicle is started, and wherein a work trip ending location is recorded when the vehicle is stopped.

9. The vehicle key activated travel log system of claim 2, wherein information from the first log book is retrievable by a user via a user's account with a telematics server.

10. The vehicle key activated travel log system of claim 2, further comprising a second work key for business travel having a third key identification code, wherein the travel log unit is activated to generate a second log book when a key identification unit recognizes that the second work key is used to start the vehicle.

11. A vehicle key activated travel log system in a vehicle, comprising
a work key for business travel having a first identification code;
a private use key for personal travel having a second identification code different from the first identification code;
a key code transceiver;
a travel log unit activated to generate a log book when a key used to start the vehicle is identified as the work vehicle key;
a travel log display subunit in a human machine interface (HMI) device to display information from the log book; and
an input and output subunit in the HMI device for input and output of travel-related information and data.

12. The vehicle key activated travel log system of claim 11, wherein the log book includes a date of a work trip, a work trip start time, a work trip end time, an odometer reading at a start of the work trip, and an odometer reading at an end of the work trip.

13. The vehicle key activated travel log system of claim 11, further comprising a data port for transferring data of the log book, wherein the data port is disposed in a HMI device of the vehicle, or in the work key.

14. A method of generating a travel log for a vehicle comprising:
receiving a first key identification code embedded in a work key or a second key identification code embedded in a private use key, each of the work key and the private key for starting the vehicle; and
generating a log book by a travel log unit responsive to the first key identification code being identified as starting the vehicle.

15. The method of claim 14, wherein generating the log book comprises recording a date of a work trip, a work trip start time, a work trip end time, an odometer reading at a start of the work trip and an odometer reading at an end of the work trip.

16. The method of claim 15, further comprising receiving vehicle location information, and recording a work trip start location and a work trip end location into the log book.

17. The method of claim 16, further comprising receiving an input from a user via a user interface of a human machine interface (HMI) device in the vehicle and recording the input into the log book, wherein the input includes a purpose of the trip, a company visited, or people visited.

18. The method of claim 17, wherein only the input by the user can be modified by the user.

19. The method of claim 14, further comprising transmitting information from the log book to a personal computing device or a storage device via a data port of a human machine interface (HMI) device in the vehicle.

20. The method of claim 14, wherein the travel log unit is not activated when the second key identification code is identified to start the vehicle.
